(19) United States
(12) Patent Application Publication
(10) Pub. No.: US 2026/0023973 A1
(43) Pub. Date: Jan. 22, 2026

(54) Configuration and Training of Classification Models

(71) Applicant: Google LLC, Mountain View, CA (US)

(72) Inventor: Huy Thong Nguyen, Mountain View, CA (US)

(21) Appl. No.: 18/776,895

(22) Filed: Jul. 18, 2024

(51) Int. Cl. G06N 3/0895; G06N 3/045

(52) U.S. Cl. CPC G06N 3/0895; G06N 3/045

(57) ABSTRACT

Methods, systems, devices, and non-transitory computer readable media for training machine-learning models are provided. The disclosed technology can include receiving input samples associated with classification concepts. Based on inputting the input samples into a first plurality of machine-learned models, classification outputs comprising labels and confidence scores can be generated. The first plurality of machine-learned models can comprise one or more multimodal large language models (LLMs) and one or more domain-specific models. Annotated input samples comprising the input samples, the classification outputs, and identifiers that identify each of the first plurality of machine-learned models that generated each of the classification outputs can be generated. Furthermore, based on the annotated input samples, one or more second machine-learned models can be trained. The training can comprise modifying parameters of the one or more second machine-learned models based on the confidence scores.

### FIELD

The present disclosure relates generally to the configuration and training of machine-learning models. More particularly, the present disclosure relates to training classification models based on annotated training data generated by machine-learned models.

### BACKGROUND

Machine-learning systems may be used to perform a variety of operations. In particular, machine-learning systems can be used to detect or recognize objects in images. However, training machine-learning systems to detect and recognize images can require a large amount of training data and doing so can be expensive, labor intensive, and time consuming. Further, the quality of training data can be reflected in the quality of the machine-learning models that are trained using that training data. As a result, the effectiveness of image detection and recognition tasks may depend on the effectiveness with which large amounts of high-quality training data can be produced. Accordingly, there may be different approaches to acquiring or producing training data for machine-learning systems.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of training machine-learning models. The computer-implemented method can comprise receiving, by a computing system comprising one or more processors, a plurality of input samples associated with a plurality of classification concepts. The computer-implemented method can comprise generating, by the computing system, based on inputting the plurality of input samples into a first plurality of machine-learned models, a plurality of classification outputs comprising a plurality of labels and a plurality of confidence scores. The first plurality of machine-learned models can comprise one or more multimodal large language models (LLMs) and one or more domain-specific models. The computer-implemented method can comprise generating, by the computing system, a plurality of annotated input samples comprising the plurality of input samples, the plurality of classification outputs, and a plurality of identifiers that identifies each of the first plurality of machine-learned models that generated each of the plurality of classification outputs. The computer-implemented method can comprise training, by the computing system, based on the plurality of annotated input samples, one or more second machine-learned models, wherein the training comprises modifying a plurality of parameters of the one or more second machine-learned models based on the plurality of confidence scores.

Another example aspect of the present disclosure is directed to one or more tangible non-transitory computer-readable media storing computer-readable instructions that when executed by one or more processors cause the one or more processors to perform operations. The operations can comprise receiving a plurality of input samples associated with a plurality of classification concepts. The operations can comprise generating, based on inputting the plurality of input samples into a first plurality of machine-learned models, a plurality of classification outputs comprising a plurality of labels and a plurality of confidence scores. The first plurality of machine-learned models can comprise one or more multimodal large language models (LLMs) and one or more domain-specific models. The operations can comprise generating a plurality of annotated input samples comprising the plurality of input samples, the plurality of classification outputs, and a plurality of identifiers that identifies each of the first plurality of machine-learned models that generated each of the plurality of classification outputs. The operations can comprise training, based on the plurality of annotated input samples, one or more second machine-learned models, wherein the training comprises modifying a plurality of parameters of the one or more second machine-learned models based on the plurality of confidence scores.

Another example aspect of the present disclosure is directed to a computing system comprising: one or more processors; one or more non-transitory computer-readable media storing instructions that when executed by the one or more processors cause the one or more processors to perform operations. The operations can comprise receiving a plurality of input samples associated with a plurality of classification concepts. The operations can comprise generating, based on inputting the plurality of input samples into a first plurality of machine-learned models, a plurality of classification outputs comprising a plurality of labels and a plurality of confidence scores. The first plurality of machine-learned models can comprise one or more multimodal large language models (LLMs) and one or more domain-specific models. The operations can comprise generating a plurality of annotated input samples comprising the plurality of input samples, the plurality of classification outputs, and a plurality of identifiers that identifies each of the first plurality of machine-learned models that generated each of the plurality of classification outputs. The operations can comprise training, based on the plurality of annotated input samples, one or more second machine-learned models, wherein the training comprises modifying a plurality of parameters of the one or more second machine-learned models based on the plurality of confidence scores.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that generates annotated input samples and trains machine-learning models according to example embodiments of the present disclosure;

FIG. 1B depicts a block diagram of an example computing device that generates annotated input samples and trains machine-learning models according to example embodiments of the present disclosure;

FIG. 1C depicts a block diagram of an example computing device that generates annotated input samples and trains machine-learning models according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of a computing system comprising machine-learned models configured to process input samples according to example embodiments of the present disclosure;

FIG. 5 depicts an example of a computing system comprising machine-learned models configured to process an annotated input sample according to example embodiments of the present disclosure;

FIG. 6 depicts a flow chart diagram of an example method to generate annotated input samples and train machine-learning models according to example embodiments of the present disclosure; and

FIG. 7 depicts a flow chart diagram of an example method of training machine-learning models according to example embodiments of the present disclosure.

Reference numerals that are repeated across plural figures are intended to identify the same features in various implementations.

### DETAILED DESCRIPTION

In general, the present disclosure is directed to automatically generating training data (e.g., training data that is generated without manual labelling) and training machine-learned models based on the automatically generated training data. In particular, the disclosed technology can train classification models based on annotated training data that is generated by a combination of multimodal large language models and domain-specific models. Further, the disclosed technology can implement machine-learned models that have been configured and/or trained to generate classification outputs comprising labels and confidence scores associated with input samples that can be annotated with an identifier that indicates which of the machine-learned models generated the classification outputs. The annotated input samples can then be used as training data to configure and/or train another machine-learned model (e.g., a machine-learned model that is different from the machine-learned model that generated the classification outputs).

For example, a computing system can receive a plurality of input samples associated with a plurality of classification concepts. The plurality of input samples can include images of various animals that are associated with the classification concept animals. Further, based on inputting the plurality of input samples into a first plurality of machine-learned models, a plurality of classification outputs can be generated. The plurality of classification outputs can comprise a plurality of labels and a plurality of confidence scores. For example, the plurality of classification outputs can be associated with the plurality of input samples and comprise a plurality of labels comprising names of animals (e.g., dog, cat, or crocodile) and a plurality of confidence scores indicating an estimated probability that a label is accurate.

The first plurality of machine-learned models can comprise one or more multimodal large language models (LLMs) and/or one or more domain-specific models. For example, the one or more multimodal LLMs can comprise a machine-learned model that is configured and/or trained to classify a variety of animals (e.g. multiple types of animals from different species) and the domain specific models can comprise machine-learned models that are specifically configured and/or trained to classify images of specific types of animals (e.g., a single type of animal from a single species). For example, the multimodal LLMs can be configured and/or trained to classify images of a plurality of animal species belonging to a plurality of animal families comprising mammals, reptiles, birds, fish, and amphibians. In comparison, the domain-specific models can be configured and/or trained to classify images of different types of dogs (e.g., Pekingese, Chihuahua, and/or Labrador retriever) or different types of cats (e.g., Persian, American Shorthair, and/or Siamese).

The domain-specific models may have greater classification accuracy than the multimodal model when classifying images that are from a domain that the domain-specific model is configured and/or trained to classify. The multimodal may have greater accuracy than a domain-specific model when classifying images that are outside the domain the domain-specific model is configured and/or trained to classify. The computing system can then generate a plurality of annotated input samples that include the plurality of input samples, the plurality of classification outputs, and a plurality of identifiers that identifies each of the first plurality of machine-learned models that generated each of the plurality of classification outputs. For example, if the first plurality of machine-learned models comprises a first model, a second model, and a third model, each of the plurality of annotated input samples would be processed by the first model, the second model, or the third model.

Based on the plurality of annotated input samples, the computing system can train one or more second machine-learned models that are different from the first plurality of machine-learned models. Training the one or more second machine-learning models can comprise modifying a plurality of parameters of the one or more second machine-learned models based on the plurality of confidence scores. For example, weights of the parameters of the one or more second machine-learned models can be increased and/or decreased based on the extent to which the parameters contribute to reducing a loss associated with the accuracy of classifying the plurality of annotated input samples. Over a plurality of iterations, the one or more second machine-learned models can be configured and/or trained to achieve a high level of accuracy of classifying input samples. As such, the disclosed technology allows for improved training of machine-learned models based on automatically generated training data that comprises annotated input samples. The disclosed technology therefore enables the generation of higher quality training data that can improve the performance of machine-learned models trained using the training data.

The disclosed technology can be implemented in a computing system (e.g., a model training computing system) that is configured to access data and/or perform operations on the data. For example, the operations performed by the computing system can comprise receiving input samples, generating a plurality of classification outputs, generating a plurality of annotated input samples, and training one or more machine-learned models. Further, the computing system can leverage a plurality of machine-learned models that have been configured and/or trained to generate outputs that can comprise a plurality of classification outputs comprising a plurality of labels and/or a plurality of confidence scores.

The computing system can be included as part of a system that includes a server computing device that receives data comprising input samples from a client computing device, performs operations based on the data and sends output comprising annotated input samples back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the generation of classification outputs, generation of annotated input samples that can assist a user in the task of processing input samples that are used to train machine-learning models.

The computing system can receive, access, and/or retrieve a plurality of input samples. The plurality of input samples can comprise a plurality of images (e.g., color, greyscale, and/or black and white images), a plurality of video segments, a plurality of audio samples, and/or a plurality of text segments. In some embodiments, the plurality of training samples can be formatted to facilitate the training of a machine-learning model. For example, input samples comprising images can be formatted to have the same or similar resolution. The plurality of input samples can be associated with a plurality of classification concepts. The plurality of classification concepts can comprise one or more indications of a class or category associated with an input sample. For example, an image of an apple can be associated with a classification concept indicating that the classification concept is food.

In some embodiments, the plurality of input samples can comprise a plurality of images (e.g., photographic images) associated with one or more classification concepts associated with one or more objects that are depicted in the plurality of images. For example, an image of a peacock can include classification concepts comprising bird, wildlife, and/or animal. Further, an image of a group of people in a restaurant smiling and eating a meal can include classification concepts comprising restaurant, party, enjoyment, and/or happiness. Further, the plurality of images can include a plurality of points (e.g., pixels) that indicate visual information about a portion (e.g., x, y coordinates of a two-dimensional image or x, y, z coordinates of a three-dimensional image) of the plurality of images. Further, the plurality of images can comprise information associated with visual features of each of the plurality of points (e.g., a hue, saturation, and/or brightness).

The computing system can generate a plurality of classification outputs. Generating the plurality of classification outputs can be based on inputting the plurality of input samples into a first plurality of machine-learned models. The plurality of classification outputs can comprise a plurality of labels and a plurality of confidence scores. A label can comprise one or more indications that classify and/or identify an input sample. For example, if an input sample is an image of a person playing a piano, the label can comprise pianist and/or piano. The plurality of confidence scores can be associated with the plurality of labels.

A confidence score can indicate a probability that a label accurately classifies an image with which the label is associated. Further, each of the plurality of confidence scores can indicate a probability that a label is accurate. For example, a (high) confidence score of 0.95 on a scale of 0.0 to 1.0 can indicate a 95% probability that a label is accurate (e.g., the label accurately describes an image associated with the confidence score). By way of further example, a (low) confidence score of 0.15 on a scale of 0.0 to 1.0 can indicate a 15% probability that a label is accurate (e.g., the label accurately describes an image associated with the confidence score). The plurality of confidence scores can comprise numerical values (e.g., 0.0 to 1.0 or 0% to 100%) in which the plurality of confidence scores are positively correlated with the accuracy of a label (e.g., a highly accurate label can be associated with a high confidence score and a less accurate label can be associated with a low confidence score).

The first plurality of machine-learned models can comprise one or more multimodal large language models (LLMs) and/or one or more domain-specific models. The one or more multimodal LLMs can comprise one or more machine-learned models that are configured and/or trained to generate classification outputs of a variety of different classes of input samples (e.g., classifications of a plurality of different classes and/or types of input samples). For example, the one or more multimodal LLMs can be configured to classify foods, plants, animals, buildings, and/or vehicles. The one or more domain-specific models can be configured and/or trained to classify a smaller set of classes than the one or more multimodal LLMs (e.g., the one or more domain-specific models can be configured and/or trained to classify a single class of input sample). For example, the one or more domain-specific models can be configured and/or trained to classify foods (e.g., an apple, a slice of cake, or a plate of rice).

The computing system can generate a plurality of annotated input samples. The plurality of input samples can comprise the plurality of input samples, the plurality of classification outputs, and/or a plurality of identifiers that identifies each of the first plurality of machine-learned models that generated each of the plurality of classification outputs. For example, if an input sample comprises an image of an American shorthair cat, the plurality of annotated input samples can comprise the image of the American shorthair cat, a classification output comprising a label classifying the image as an American shorthair cat and a confidence score of 0.98 on a scale of 0.0 to 1.0, and an identifier that identifies the machine-learned model that generated the classification output. By way of further example, if a machine-learned model (e.g., a machine-learned model identified by the identifier “MODEL 1”) generates an annotated input sample comprising an input sample <image sample> in which “<image sample>” is an image (e.g., a two-dimensional image), a classification output indicating that <image sample> depicts a bird, and a confidence score of 0.8 on a scale of 0.0 to 1.0 (0.0 being the lowest confidence score and 1.0 being the highest confidence score), the annotated input sample can indicate and/or comprise “MODEL 1 + <image sample> + bird --> 0.8.”

The computing system can configure and/or train one or more machine-learned models (e.g., the one or more second machine-learned models). Training the one or more second machine-learned models can be based on the plurality of annotated input samples. Further, training the one or more second machine-learned models can comprise modifying a plurality of parameters of the one or more second machine-learned models based on the plurality of confidence scores. For example, the one or more second machine-learned models can comprise a plurality of parameters that are associated with a plurality of features (e.g., visual features of an image).

The plurality of parameters can be associated with a plurality of weights that indicate an extent to which the plurality of parameters contribute to reducing and/or minimizing a loss (e.g., a loss that is inversely correlated with the accuracy of the output generated by the one or more second machine-learned models). For example, the one or more second machine-learned models can be trained to classify images. The one or more second machine-learned models can comprise a plurality of parameters that are modified over a plurality of iterations in which training input samples are inputted into the one or more second machine-learned models.

After each of the plurality of iterations, a loss associated with the accuracy of the output generated by the one or more second machine-learned models can be generated (e.g., a loss that is inversely correlated with the accuracy of the output of the one or more second machine-learned models). The weights of the parameters that contribute to decreasing the loss can be increased and the weights of the parameters that do not contribute to decreasing the loss or that increase the loss can be decreased. The one or more second machine-learned models can be trained until some threshold accuracy level (e.g., 0.95 on a scale of 0.0 to 1.0 in which 1.0 is the highest accuracy and 0.0 is the lowest accuracy) is achieved.

In some embodiments, the plurality of input samples can be associated with a plurality of different conceptual domains. For example, the plurality of conceptual domains can comprise classes of concepts such as food, faces, vehicles, buildings, and/or clothing that are associated with the concepts that a machine-learned model is configured and/or trained to classify.

Further, the one or more multimodal large language models can be configured and/or trained based on training data associated with the plurality of different conceptual domains. For example, the one or more multimodal LLMs can be trained using training data comprising a plurality of images of objects belonging to various conceptual training domains comprising food, clothing, animals, geographic locations, vehicles, electronic devices, and/or buildings.

In some embodiments, the one or more multimodal large language models can be configured to classify images associated with a plurality of different conceptual domains. For example, the plurality of input samples can comprise images from conceptual domains comprising food (e.g., images of food), furniture (e.g., images of furniture), buildings (e.g., images of buildings), and cutlery (e.g., images of cutlery). The one or more multimodal LLMs can be configured and/or trained using training data comprising images from a plurality (e.g., two of the plurality of conceptual domains, a majority of the plurality of conceptual domains, or all of the plurality of conceptual domains) of the conceptual domains of the plurality of input samples (e.g., food, furniture, buildings, and cutlery).

In some embodiments, the one or more domain-specific models can be trained based on the plurality of input samples associated with a subset of the plurality of different conceptual domains. For example, the plurality of input samples can comprise images from conceptual domains comprising food (e.g., images of food), furniture (e.g., images of furniture), buildings (e.g., images of buildings), and cutlery (e.g., images of cutlery). The plurality of domain-specific models can be configured and/or trained using training data comprising images of food and cutlery, two of the conceptual domains of the plurality of input samples.

In some embodiments, the subset of the plurality of different conceptual domains can comprise a single conceptual domain. For example, the plurality of domain-specific models can comprise images of food, a single (one) conceptual domain of the plurality of input samples.

In some embodiments, the one or more domain-specific models can be configured and/or trained to classify images associated with a specific conceptual domain. For example, the plurality of domain-specific models can be configured and/or trained using training data comprising images of food, a single (one) conceptual domain of the plurality of input samples.

In some embodiments, the plurality of input samples can comprise one or more images associated with the specific conceptual domain. In some embodiments, the plurality of input samples can comprise one or more images associated with a specific conceptual domain. For example, the plurality of input samples can comprise only images of food.

In some embodiments, the first plurality of machine-learned models can be configured to classify images based on a plurality of input samples that can comprise one or more images and/or one or more prompts associated with the images. For example, the plurality of input samples can comprise an image and one or more prompts to a search engine or machine-learning model that are associated with the image.

In some embodiments, the plurality of confidence scores indicate an accuracy associated with the plurality of labels generated by the first plurality of machine-learned models. Further, the plurality of confidence scores can comprise a probability that the label generated by a machine-learned model of the first plurality of machine-learned is accurate. The plurality of confidence scores can comprise a plurality of numerical values in which a higher numerical value can indicate a higher probability that the label generated by a machine-learned model of the first plurality of machine-learned is accurate.

In some embodiments, training, based on the plurality of annotated input samples, one or more second machine-learned models can comprise the one or more second machine-learned models receiving the plurality of annotated input samples (e.g., receiving the plurality of input samples from a local computing system or a remote computing system).

Further, training the one or more second machine-learned models can comprise generating and/or determining, based on inputting the plurality of annotated input samples into the one or more second machine-learned models, a plurality of predicted classification outputs. For example, the plurality of annotated input samples can include a plurality of images of foods associated with a corresponding plurality of labels, confidence scores, and identities of the plurality of machine-learned models that generated the plurality of classification outputs. Based on the plurality of annotated input samples, the one or more second machine-learned models can perform one or more operations and generate an output comprising a plurality of predicted classification outputs associated with the corresponding plurality of annotated input samples.

Further, training the one or more second machine-learned models can comprise determining a loss based on one or more differences between the plurality of predicted classification outputs and the plurality of classification outputs. The loss can be inversely proportional to an accuracy of the plurality of predicted classification outputs generated by the one or more second machine-learned models. The loss can be associated with the accuracy of the plurality of predicted classification outputs generated by the one or more second machine-learned models. A low loss (e.g., a low loss value) can be associated with a high accuracy of the plurality of predicted classification outputs. A high loss (e.g., a high loss value) can be associated with a low accuracy of the plurality of predicted classification outputs. Determining the one or more differences between the plurality of predicted classification outputs and the plurality of classification outputs can comprise comparing the plurality of predicted classification outputs to the plurality of classification outputs. For example, training the one or more second machine-learned models can be performed over a plurality of iterations and the one or more differences between the plurality of predicted classification outputs and the plurality of classification outputs can be determined based on one or more comparisons of the plurality of predicted classification outputs to the plurality of classification outputs after each of the plurality of iterations. Based on the one or more differences between the plurality of predicted classification outputs and the plurality of classification outputs the loss can be determined after each of the plurality of iterations.

The loss can increase in proportion to the number of the one or more differences between the plurality of predicted classification outputs and the plurality of classification outputs. For example, if there are five differences between the plurality of predicted classification outputs and the plurality of classification outputs, the loss can be greater than if there is one difference between the plurality of predicted classification outputs and the plurality of classification outputs. Further, the loss can increase in proportion to the magnitude of differences between the plurality of predicted classification outputs and the plurality of classification outputs. For example, a predicted classification output that is slightly different from a classified output (e.g., a slice of cake is classified as a slice of pie) can result in a greater loss than a predicted attribute that is significantly different from a ground-truth attribute (e.g., (e.g., an automobile is classified as a bicycle).

A loss function can be used to determine the loss. Further, the loss function can be used to evaluate the one or more differences between the plurality of predicted classification outputs and the plurality of classification outputs. For example, the loss function can comprise an L2 loss function in which the loss is based on the squared differences between the value of the plurality of classification outputs and the plurality of predicted classification outputs.

Further, training the one or more second machine-learned models can comprise modifying the plurality of parameters of the one or more second machine-learned models to minimize the loss. The plurality of parameters can be associated with one or more features (e.g., visual features and/or spatial features) of the plurality of annotated input samples and can be used to determine the predicted classification outputs. Further, the plurality of parameters can be associated with a plurality of weights that can be associated with an extent to which the plurality of parameters contribute to determining the loss. Training the one or more second machine-learned models can comprise modifying the plurality of weights to minimize the loss.

Training the machine-learned model can be performed over a plurality of iterations. In each iteration of training, the weights of the parameters that contribute to increasing the loss can be reduced, the weights of the parameters that do not contribute to increasing or decreasing the loss can be kept unmodified, and/or the weights of the parameters that contribute to decreasing the loss can be increased. As a result, the plurality of weights of the plurality of parameters can be positively correlated with the loss such that parameters that are more heavily weighted can contribute more to determining the predicted classification outputs than parameters that are less heavily weighted. Over the plurality of iterations, the loss can be minimized until a threshold loss that corresponds to a high accuracy of the machine-learned model determining the plurality of predicted classification outputs is achieved. For example, the loss can be minimized until a threshold loss associated with 99% accuracy is achieved by the machine-learned model. In some embodiments, the loss can be minimized based on use of an L2 loss function.

In some embodiments, a magnitude of the modification of the plurality of parameters can be positively correlated with an identifier that identifies a machine-learned model that is configured and/or trained to classify an input sample that is associated with a classification concept that matches the classification concept of the domain-specific model. For example, the plurality of predicted classification outputs that are based on the plurality of annotated input samples that are associated with domain-specific models that (e.g., a domain-specific model that classifies input samples associated with classification concepts that the domain-specific model is configured and/or trained to classify) can have high confidence scores can result in a greater modification of the plurality of weights of the plurality of parameters than a multimodal model with a lower confidence score.

In some embodiments, a magnitude of the modification of the plurality of parameters can be positively correlated with the magnitude of the plurality of confidence scores. For example, the plurality of annotated input samples that comprise high confidence scores (e.g., confidence scores greater than 0.9 on a scale of 0.0 to 1.0) can result in greater modification of the plurality of parameters then the plurality of annotated input samples that comprise low confidence scores (e.g., confidence scores less than 0.4 on a scale of 0.0 to 1.0).

In some embodiments, the one or more second machine-learned models can receive one or more input images. The one or more second machine-learned models can, based on input comprising the one or more input images, generate output comprising one or more classifications of the one or more input images. Generation of the one or more classifications of the one or more input images can be based on detection and/or recognition of one or more objects in the one or more input images.

For example, the one or more second machine-learned models can be configured and/or trained to receive an image of a face and, as part of an authorization process to access a computing device or computing application, generate an output that identifies the image of the face and determines whether the face matches an authorized face. By way of further example, the one or more second machine-learned models can be configured and/or trained to receive an image of an article of clothing items and, as part of an inventory generation process to describe articles of clothing (e.g., describing an article of clothing as summer or winter wear, or as trousers or a shirt), generate an output that identifies and categorizes the article of clothing. Further, the one or more second machine-learned models can be configured and/or trained to receive one or more images via a camera (e.g., a smartphone camera) and, as part of an object recognition application, detect, recognize, and/or classify one or more objects that are received from the camera and generate an output that identifies and categorizes the one or more objects.

The systems, methods, devices, and/or computer-readable media (e.g., tangible non-transitory computer-readable media) in the disclosed technology can provide a variety of technical effects and benefits including improving the accuracy of machine-learning computing systems and/or increasing the efficiency of computing resource utilization. In particular, the disclosed technology can improve the efficiency of resource utilization by reducing the number of different machine-learned models that are used to process input samples, which can result in the use of less storage capacity and a reduction in the use of computational resources that are used to process the input samples. Further, the reduction in the use of computational resources can reduce the amount of energy used in processing by a computing system as well as reducing the amount of heat that is generated by processing input samples, which can result in environmental benefits. Further, by automatically generating high-quality training data (e.g., high accuracy labelled input samples used to configure and/or train machine-learned models) the disclosed technology can increase the speed of generating labelled training data and improve the efficiency of resource utilization by reducing the use of manually labelled training data.

Additionally, the high-quality training data that is automatically generated by the disclosed technology can increase the overall volume of training data that is used to configure and/or train machine-learned models. A greater volume of high-quality training data can allow for the development of machine-learned models that are able to generate more accurate outputs that can be used for a variety of different purposes (e.g., image classification). For example, a greater volume of high-quality training data can allow for greater machine-learned model performance when performing tasks such as creating content (e.g., machine-learned model text and/or images) and/or chatting with users.

As such, the disclosed technology can assist the user of a machine-learning system (e.g., a multimodal LLM) in more effectively performing a variety of tasks with the specific benefits of improving the accuracy of machine-learning computing systems and increasing the efficiency of computing resource utilization. Further, the specific benefits provided to users can be used to improve the effectiveness and/or performance of a wide variety of services and/or devices including computing devices and/or machine-learning applications. Accordingly, the improvements offered by the disclosed technology can result in tangible benefits to a variety of devices and/or systems including mechanical, electronic, and computing systems that are associated with configuring and/or training machine-learning models.

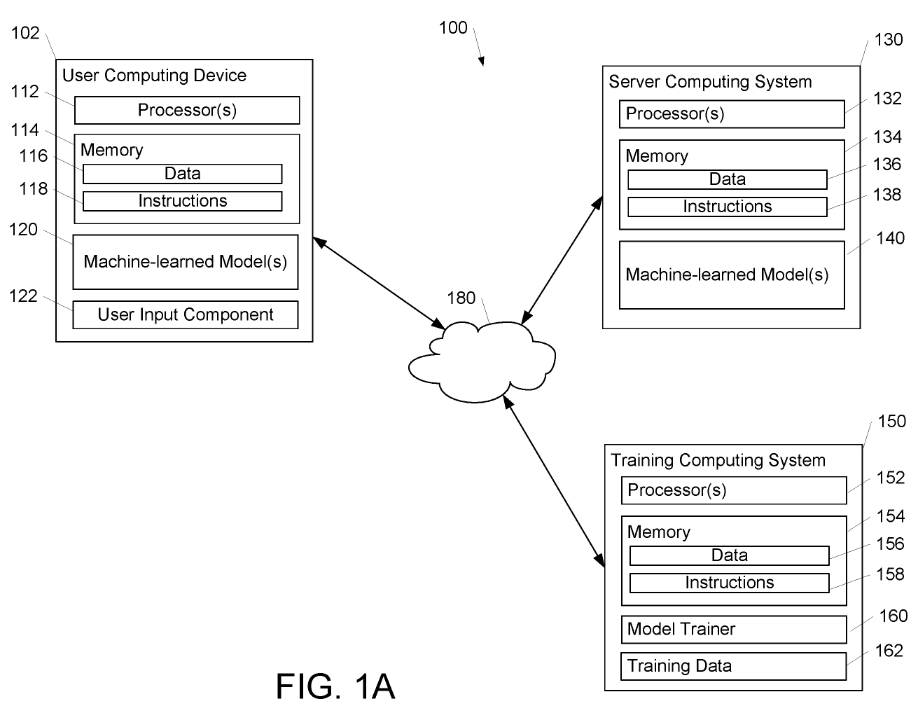

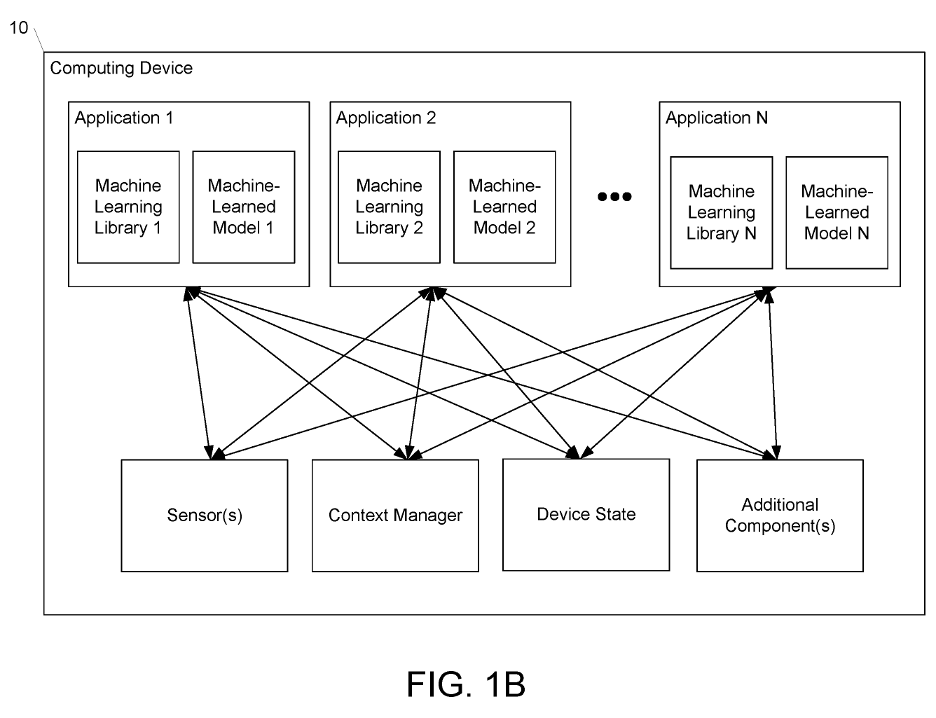

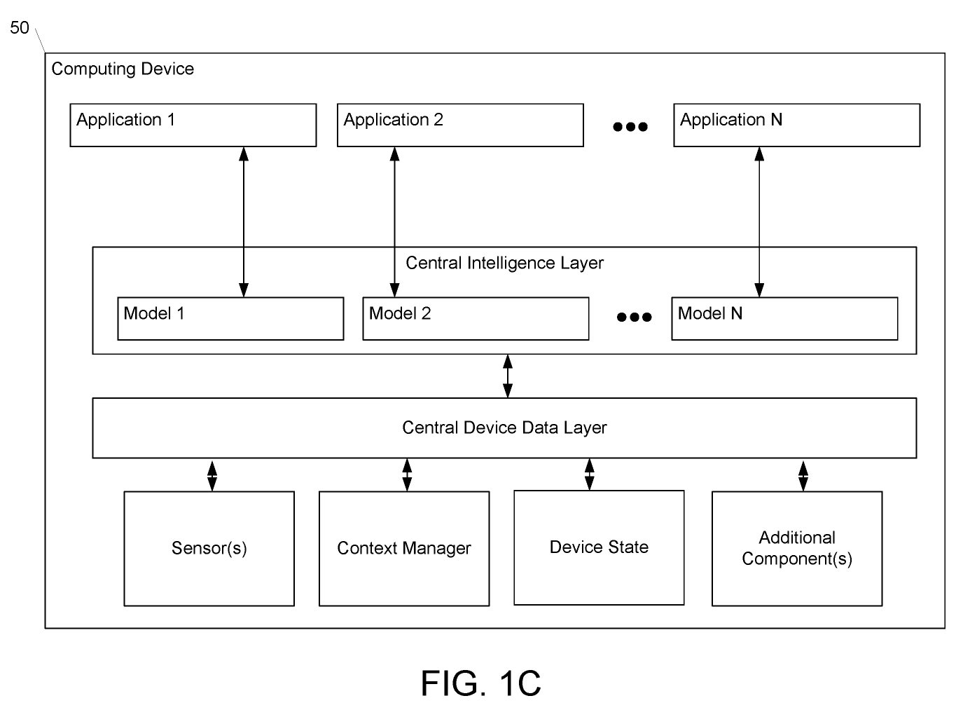

With reference now to the figures, example embodiments of the present disclosure will be discussed in further detail. FIG. 1A depicts a block diagram of an example computing system that generates annotated input samples and trains machine-learning models according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Examples of one or more machine-learned models 120 are discussed with reference to FIGS. 1-7.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel annotated input sample generation operations across multiple instances of the one or more machine-learned models 120).

More particularly, the one or more machine-learned models 120 can comprise one or more machine-learned models (e.g., one or more multimodal LLMs and/or one or more domain-specific models) that are configured and/or trained to receive input samples, generate a plurality of classification outputs, generate a plurality of annotated input samples, and train one or more machine-learned models.

Additionally or alternatively, one or more machine-learned models 140 (e.g., one or more multimodal LLMs and/or one or more domain-specific models) can be included in or otherwise stored and implemented by the server computing system 130 that communicates with the computing device 102 according to a client-server relationship. For example, the one or more machine-learned models 140 can be implemented by the server computing system 130 as a portion of a web service (e.g., an annotated input sample generation service and/or a machine-learned model training service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-7.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include a plurality of input samples (e.g., images, text segments, audio samples, and/or video samples) that can be associated with a plurality of classification concepts. For example, the training data 162 can comprise a plurality of images of foods and the associated classification concept (e.g., food). The training data 162 can also comprise ground-truth classification outputs that indicate labels and confidence scores associated with the plurality of input samples in the training data 162. Further, the training data 162 can include various publications (e.g., books, articles, and/or journals) that can be received from a variety of sources including libraries, the Internet (e.g., websites), and/or devices that can comprise sensors and can be configured to generate and/or receive data (e.g., smartwatches, smartphones, and/or other computing devices that can be configured to receive sensor data and/or data entered by a user). The model trainer 160 can train and/or retrain the one or more machine-learned models 120 and/or the one or more machine-learned models 140 based on additional data from the training data 162 which can comprise additional input sample data (e.g., updated input samples), new types of input sample data (e.g., new types of input sample data based on sensor data from new sensor types), and/or one or more modifications to existing input sample data.

In some implementations, if a user has provided consent (e.g., the user provides affirmative consent for another party to use the user’s image data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can comprise any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio data or visual data).

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device that processes images according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include an input sample processing application, annotated input sample generation application, a machine-learned model training application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that processes images and/or generates attributes according to example embodiments of the present disclosure. A computing device 50 can be a user computing device or a server computing device.

The computing device 50 includes a number of applications (e.g., applications 1 through N). Each application is in communication with a central intelligence layer. Example applications include an input processing application (e.g., an application that is used to process input samples and generate classification outputs), a machine-learned model training application (e.g., an application that is used to train machine-learned models based on annotated input samples), a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

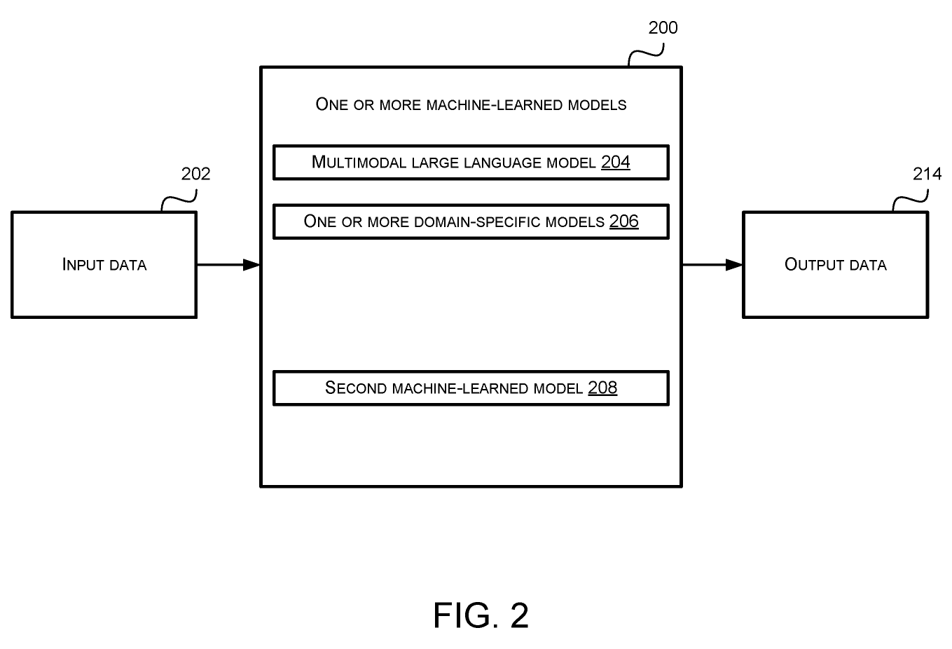

FIG. 2 depicts a block diagram of examples of machine-learned models according to example embodiments of the present disclosure. In some implementations, the one or more machine-learned models 200 can be trained to receive input data 202 that can comprise a plurality of input samples associated with a plurality of classification concepts (e.g., images of animals associated with the classification concept “ANIMALS”). As a result of receipt of the input data 202 the one or more machine-learned models 200 can generate output data 214 that can comprise a plurality of classification outputs comprising a plurality of labels and/or a plurality of confidence scores.

In some implementations, the one or more machine-learned models 200 can include a multimodal large language model 204 (e.g., a multimodal modal that is configured and/or trained using a wide variety of training data that includes input samples from different conceptual domains) that is operable to determine the plurality of classification outputs. Further, the one or more machine-learned models 200 can include one or more domain-specific models 206 (e.g., one or more domain-specific models that are configured and/or trained using training data that includes input samples from a single conceptual domain) that is operable to determine the plurality of classification outputs.

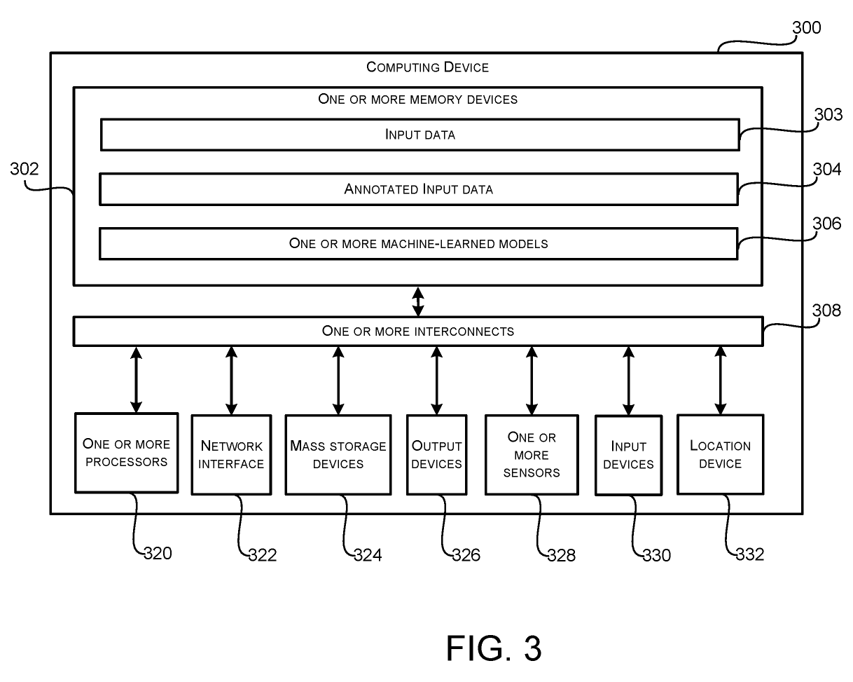

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, input data 303, annotated input data 304, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., input data and/or annotated input data) based on a plurality of input samples (e.g., images) detected by the one or more sensors 328 of the computing device 300) and/or data that is received from another computing device (e.g., input data and/or annotated input data that is generated by a remote computing device).

The one or more memory devices 302 can store information and/or data (e.g., the input data 303, the annotated input data 304, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with receiving input samples, generating a plurality of classification outputs, generating a plurality of annotated input samples, and training one or more machine-learned models.

The input data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the input data 303 can include information associated with a plurality of input samples (e.g., images of food, clothing, places, animals, and/or vehicles) associated with a plurality of classification concepts. In some embodiments, the input data 303 can be received from one or more computing systems (e.g., the server computing system 130 that is depicted in FIG. 1) which can include one or more computing systems that are remote (e.g., in another building) from the computing device 300.

The annotated input data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the annotated input data 304 can include information associated with the plurality of input samples (e.g., images of food, clothing, places, animals, and/or vehicles) of the input data 303 and further associated with a plurality of classification outputs (e.g., a label and confidence score associated with an input sample) a plurality of identifiers that identifies the machine-learned model that generated a classification concept. In some embodiments, the annotated input data 304 can be received from one or more computing systems (e.g., the server computing system 130 that is depicted in FIG. 1) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can include information associated with receiving input samples, generating a plurality of classification outputs, generating a plurality of annotated input samples, and training one or more machine-learned models. In some embodiments, the one or more machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the input data 303, the annotated input data 304, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the input data 303, the annotated input data 304, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., the input data 303 and/or the annotated input data 304) from other computing devices. The one or more mass storage devices 324 (e.g., a hard disk drive and/or a solid-state drive) can be used to store data including the input data 303, the annotated input data 304, and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images associated with the input data 303 and/or the annotated input data 304.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including one or more classification outputs and/or annotated input samples. The one or more memory devices 302 can be used to operate various applications including a mobile operating system developed specifically for mobile devices. As such, the one or more memory devices 302 can store instructions that allow the software applications to access data including data associated with a plurality of input samples and/or a plurality of annotated input samples. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

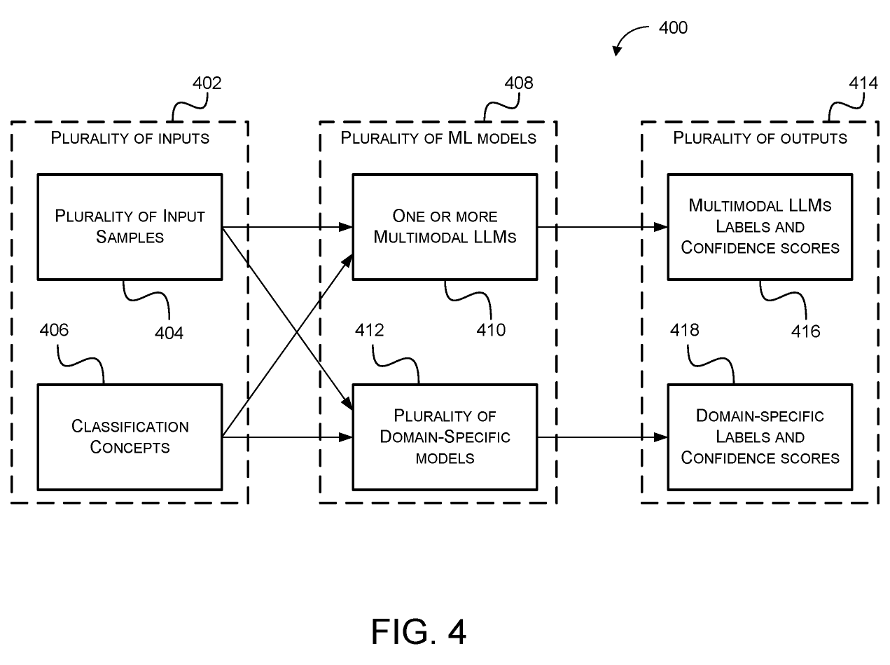

FIG. 4 depicts an example of a computing system comprising machine-learned models configured to process input samples according to example embodiments of the present disclosure. A computing system 400 can include one or more features and/or capabilities of the computing device 102, the server computing system 130, the training computing system 150, and/or the computing device 300. Furthermore, the computing system 500 can perform one or more actions and/or operations that can be performed by the computing device 102, the server computing system 130, the training computing system 150, and/or the computing device 300.

In FIG. 4, an input 402 (e.g., an input to the plurality of machine-learned models 408) can comprise a plurality of input samples 404 that are associated with a plurality of classification concepts 406. For example, the plurality of input samples 404 can comprise a plurality of images of people holding objects (e.g., smartphones, books, clothing, laptop computers, pens, notepads, cups, plates, and/or cutlery) in different settings (e.g., a restaurant, an office, a classroom, a hospital, or a home). Further, each of the plurality of input samples 404 can be associated with one of the plurality of classification concepts 406 which can comprise a general indication of the classification concept associated with each of the plurality of input samples 404 (e.g., a general concept associated with what is depicted in each of the plurality of input samples 404).

The plurality of machine-learned models 408 can receive the input 402 and perform operations on the input to classify each input. The plurality of machine-learned models 408 can comprise the one or more multimodal LLMs 410 and the plurality of domain-specific models 412. The one or more multimodal LLMs 410 can be configured and/or trained to classify a first set of classification concepts that can comprise a wide variety of different classification concepts. For example, the first set of classification concepts can comprise food, clothing, animals, geographic locations, vehicles, electronic devices, and/or buildings. The plurality of domain-specific models 412 can be configured and/or trained to classify a subset of classification concepts. For example, each of the plurality of domain-specific models 412 can be configured and/or trained to classify a subset (e.g., one concept) of the first set of classification concepts that the multimodal LLM is configured and/or trained to classify.

Further, each of the plurality of domain-specific models 412 can be configured and/or trained to classify a particular classification concept with higher accuracy than the multimodal LLM 410. For example, a domain-specific model 412 that is specifically configured and/or trained to classify food (e.g., the domain-specific model is configured and/or trained using a training dataset of one million images of food can classify images of food with a higher accuracy than the multimodal LLM 410 which was configured and/or trained to classify a wider range of classification concepts using a training dataset that comprised ten thousand images of food. Further, classification concepts that the plurality of domain-specific models 412 are not specifically configured and/or trained to classify may be classified with lower accuracy than the multimodal LLM 410. For example, a domain-specific model 412 that is configured and/or trained to classify food but not configured and/or trained to classify clothing may classify images of clothing with a lower accuracy than the multimodal LLM 410 which was configured and/or trained to classify classification concepts comprising clothing.

Further, the subset of classification concepts that each of the plurality of domain-specific models 412 is configured and/or trained to classify can be smaller than the first set of classification concepts that the one or more multimodal LLMs 410 are configured and/or trained to classify. In some embodiments, each of the plurality of domain-specific models 412 can be configured and/or trained to classify a subset of classification concepts that comprises one of the classification concepts that the multimodal LLM 410 is configured and/or trained to classify. In some embodiments, each of the plurality of domain-specific models 412 can be configured and/or trained to classify a different classification concept. Further, each of the plurality of domain-specific models 412 can be configured and/or trained to classify a subset of classification concepts that is different from the subset of classification concepts that the other domain-specific models of the plurality of domain-specific models 412 are configured and/or trained to classify.

In this example, each of the one or more multimodal LLMs 410 and the plurality of domain-specific models 412 can receive the plurality of input samples 404 and the plurality of classification concepts 406. Further, each of the plurality of machine-learned models 408 can process the input 402 and generate the plurality of outputs 414. The plurality of outputs 414 can comprise the multimodal LLMs labels and confidence scores 416 which are based on the operations performed by the one or more multimodal LLMs 410 on the input 402. Further, the plurality of outputs 414 can comprise the domain-specific labels and confidence scores 418 which are based on the operations performed by the plurality of domain-specific models 412.

For example, the plurality of machine-learned models 408 comprises one multimodal LLM 410 that is configured and/or trained to classify a first set of the plurality of classification concepts 406 comprising food, clothing, animals, geographic locations, vehicles, electronic devices, and/or buildings. Based on the input 402, the multimodal LLM 410 can generate the multimodal LLM labels and confidence scores comprising labels of each of the plurality of inputs 402 with associated confidence scores ranging from 0.7 to 0.85.

Further, the plurality of domain-specific models 412 can comprise three domain-specific models: a first model of the plurality of domain-specific models 412 that is configured and/or trained to classify a first subset of the plurality of classification concepts 406 comprising food at a high accuracy; a second model of the plurality of domain-specific models 412 that is configured and/or trained to classify a second subset of the plurality of classification concepts 406 comprising clothing at a high accuracy; and a third model of the plurality of domain-specific models 412 that is configured and/or trained to classify a third subset of the plurality of classification concepts 406 comprising animals at a high accuracy.

The first model of the plurality of domain-specific models 412 can generate domain-specific labels and confidence scores 418 for food related classification concepts that range from 0.95 to 0.99. Further, the first model of the plurality of domain-specific model 412 can generate domain-specific labels and confidence scores 418 for non-food related classification concepts that range from 0.4 to 0.6.

The second model of the plurality of domain-specific model 412 can generate domain-specific labels and confidence scores 418 for clothing related classification concepts that range from 0.96 to 0.98. Further, the second model of the plurality of domain-specific model 412 can generate domain-specific labels and confidence scores 418 for non-clothing related classification concepts that range from 0.35 to 0.5.

The third model of the plurality of domain-specific model 412 can generate domain-specific labels and confidence scores 418 for animal related classification concepts that range from 0.94 to 0.97. Further, the third model of the plurality of domain-specific model 412 can generate domain-specific labels and confidence scores 418 for non-animal related classification concepts that range from 0.5 to 0.65.

The plurality of outputs 414 can be associated with an identifier that identifies each of the plurality of machine-learned models that generated each of the plurality of outputs 414. The identifier can be used in training the plurality of machine-learned models. For example, when modifying weights of parameters, the identifier can increase or decrease the amount by which the weights of parameters are modified based on the identity of the machine-learned model that generated a predicted classification output during training.

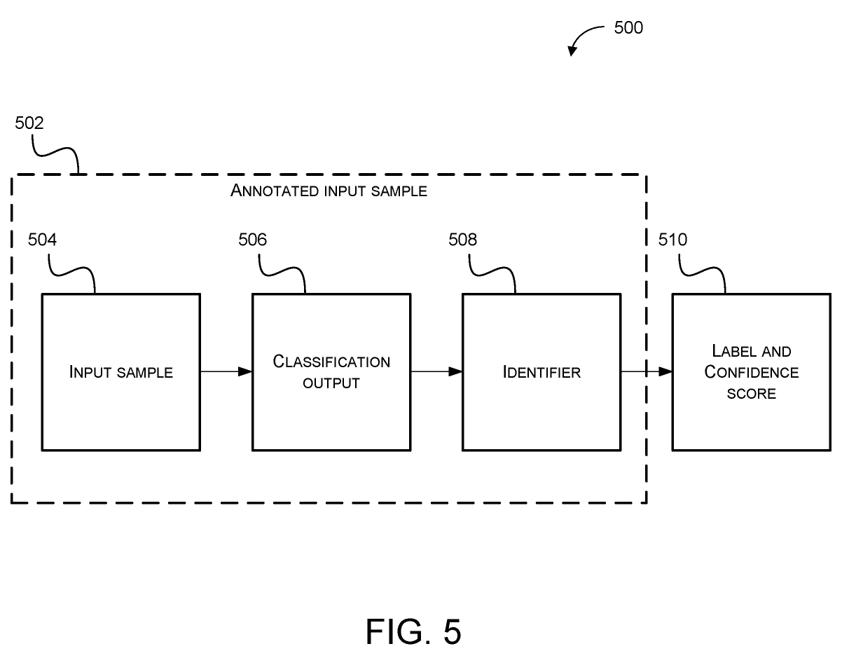

FIG. 5 depicts an example of a computing system comprising machine-learned models configured to process an annotated input sample according to example embodiments of the present disclosure. A computing system 500 can include one or more features and/or capabilities of the computing device 102, the server computing system 130, the training computing system 150, and/or the computing device 300. Furthermore, the computing system 500 can perform one or more actions and/or operations that can be performed by the computing device 102, the server computing system 130, the training computing system 150, and/or the computing device 300.

As shown in FIG. 5, the annotated input sample 502 can comprise an input sample 504, a classification output 506, and an identifier 508 of a machine-learned model that generated a label and confidence score 510. The input sample 504 can comprise a sample that is used to configure and/or train a machine-learned model. For example, the input sample 504 can comprise an image, a text segment, an audio segment, or a video segment. The classification output 506 can comprise a class that is associated with the input sample 504. For example, if the input sample 504 comprises an image of a bird, the classification output 506 can comprise a bird class which is a class that includes the bird depicted in the image. The identifier 508 can identify a machine-learned model (e.g., a multimodal model or a domain-specific model) that generated the label and confidence score 510. For example, the identifier 508 that identifies the machine-learned model that generated the annotated input sample 502 can be “MODEL 1” which can distinguish the machine-learned model that generated the annotated input sample 502 from other machine-learned models that generated other annotated input samples (e.g., the other machine-learned models that generated annotated input samples can be identified as “MODEL 2” or “MODEL 3” to distinguish those other machine-learned models from “MODEL 1”).

The label and confidence score 510 can comprise a label that classifies the input sample 504. For example, the label of the label and confidence score 510 can classify the input sample 504 as a bird. Further, the label and confidence score 510 can comprise a confidence score that indicates a probability that the label (e.g., the bird label) is accurate. For example, the confidence score can be 0.95, which can indicate that there is a high probability that the label is accurate. In some embodiments, the confidence score can be based in part on the identifier 508 and/or the classification output 506.

For example, if the machine-learned model that generated the label and confidence score 510 is a domain-specific model and the classification concept associated with the input sample 504 is associated with a conceptual domain that the domain-specific model is configured and/or trained to classify (e.g., the domain-specific model is configured and/or trained to classify birds) the confidence score can be high (e.g., greater than 0.9). If the machine-learned model that generated the label and confidence score 510 is a multimodal LLM, the confidence score generated by the multimodal LLM can be lower (e.g., less than 0.8) than that of a domain-specific model if the input sample 504 is associated with a conceptual domain that the domain-specific model is configured and/or trained to classify (e.g., the domain-specific model is configured and/or trained to classify birds). If the machine-learned model that generated the label and confidence score 510 is a domain-specific model and the classification concept is associated with a conceptual domain that the domain-specific model is not configured and/or trained to classify (e.g., the domain-specific model is not configured and/or trained to classify birds) the confidence score can be lower (e.g., less than 0.6) than that of a multimodal LLM and/or domain-specific model that is configured and/or trained to classify an input sample associated with a variety of classification concepts that can include birds.

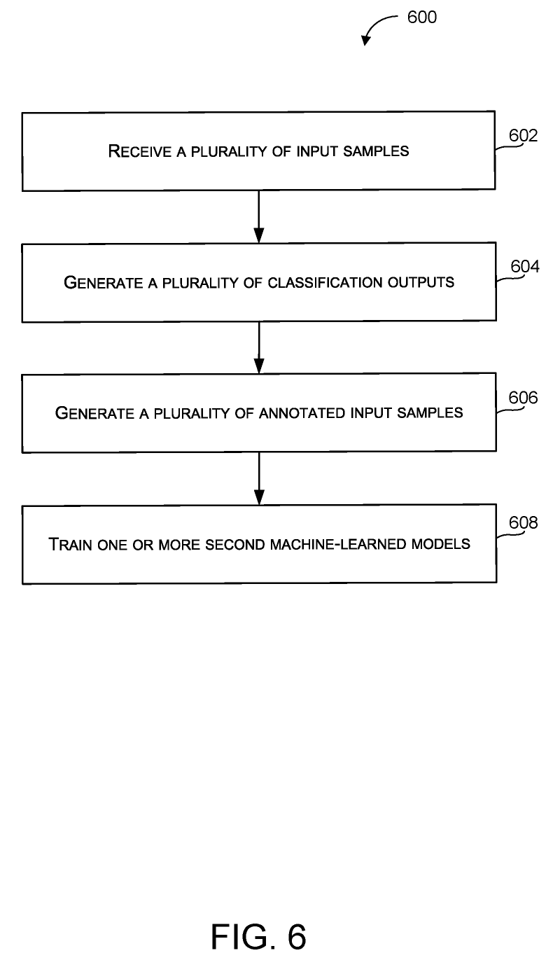

FIG. 6 depicts a flow chart diagram of an example method to generate annotated input samples and train machine-learning models according to example embodiments of the present disclosure. One or more portions of the method 600 can be executed and/or implemented on one or more computing devices or computing systems comprising, for example, the computing device 102, the server computing system 130, the training computing system 150, and/or the computing device 300. Further, one or more portions of the method 600 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include receiving a plurality of input samples associated with a plurality of classification concepts. For example, the plurality of input samples can comprise a plurality of images associated with a plurality of classification concepts that indicate concepts depicted in the plurality of images. Further, a computing system (e.g., the server computing system 130) can receive a plurality of input samples (e.g., the training data 162) which can comprise images associated with classification concepts comprising foods, plants, animals, buildings, and/or vehicles.

At 604, the method 600 can include generating, based on inputting the plurality of input samples into a first plurality of machine-learned models, a plurality of classification outputs comprising a plurality of labels and a plurality of confidence scores. The first plurality of machine-learned models can comprise one or more multimodal large language models (e.g., a multimodal LLM configured and/or trained to classify a plurality of input samples associated with a plurality of different classification concepts such as foods, plants, animals, buildings, and vehicles) and/or one or more domain-specific models (e.g., several domain-specific models each of which is configured and/or trained to classify a plurality of input samples associated with a single type of classification concept such as foods or buildings).

For example, each of the plurality of input samples can be inputted into each of the first plurality of machine-learned models. If there are 100000 different input samples and the first plurality of machine-learned models comprises one multimodal LLM and three different domain-specific models, then the 100000 different input samples would be inputted into each of the multimodal LLM and the three different domain-specific models. Further, each of the multimodal LLM and the three different domain-specific models can generate its own plurality of classification outputs based on the 100000 different input samples that each of the first plurality of machine-learned models received. By way of further example, a computing system (e.g., the server computing system 130) can implement the first plurality of machine-learned models (e.g., the one or more machine-learned models 140), which can receive input comprising the plurality of input samples (e.g., the training data 162).

At 606, the method 600 can include generating a plurality of annotated input samples comprising the plurality of input samples, the plurality of classification outputs, and/or a plurality of identifiers that identifies each of the first plurality of machine-learned models that generated each of the plurality of classification outputs. Generating a plurality of annotated input samples can comprise a computing system (e.g., the server computing system 130) determining which machine-learned model of the first plurality of machine-learned models generated each of the plurality of classification outputs. In some embodiments, each of the first plurality of machine-learned models can generate an identifier that indicates which of the first plurality of machine-learned models generated which of the plurality of classification outputs. Further, in some embodiments, a computing system can generate a plurality of identifiers based on determining (e.g., by monitoring the first plurality of machine-learned models) which of the first plurality of machine-learned models generated which of the plurality of classification outputs. For example, if the first plurality of machine-learned models comprises one multimodal LLM, a first domain-specific model, and a second domain-specific model, then a classification output generated by the multimodal LLM can be associated with an identifier generated either by the multimodal LLM or a computing system that monitors the plurality of classification outputs generated by the first plurality of machine-learned models. Further, a classification output generated by the first domain-specific model can be associated with an identifier generated either by the first domain-specific model or a computing system that monitors the generation of the plurality of classification outputs by the first plurality of machine-learned models.

Further, a computing system (e.g., the server computing system 130) can generate the plurality of annotated input samples based on the plurality of input samples (e.g., the training data 162), the plurality of classification outputs comprising the plurality of labels and the plurality of confidence scores, and the plurality of identifiers that identifies each of the first plurality of machine-learned models that generated each of the plurality of classification outputs.

At 608, the method 600 can include training, based on the plurality of annotated input samples, one or more second machine-learned models. Training the one or more second machine-learned models can comprise modifying a plurality of parameters of the one or more second machine-learned models based on the plurality of confidence scores.

For example, the server computing system 130 can train one or more second machine-learned models based on the plurality of annotated input samples. The one or more second machine-learned models can be trained over a plurality of iterations in which the one or more second machine-learned models generate a plurality of outputs (e.g., outputs that comprise classifications of the plurality of annotated input samples) based on input comprising the plurality of annotated input samples. A plurality of weights of the plurality of parameters of the one or more second machine-learned models can be modified to reduce a loss (e.g., a loss that is associated with the accuracy of the plurality of outputs) that is determined after each of the plurality of iterations. The one or more second machine-learned models can be trained until some threshold accuracy is achieved.

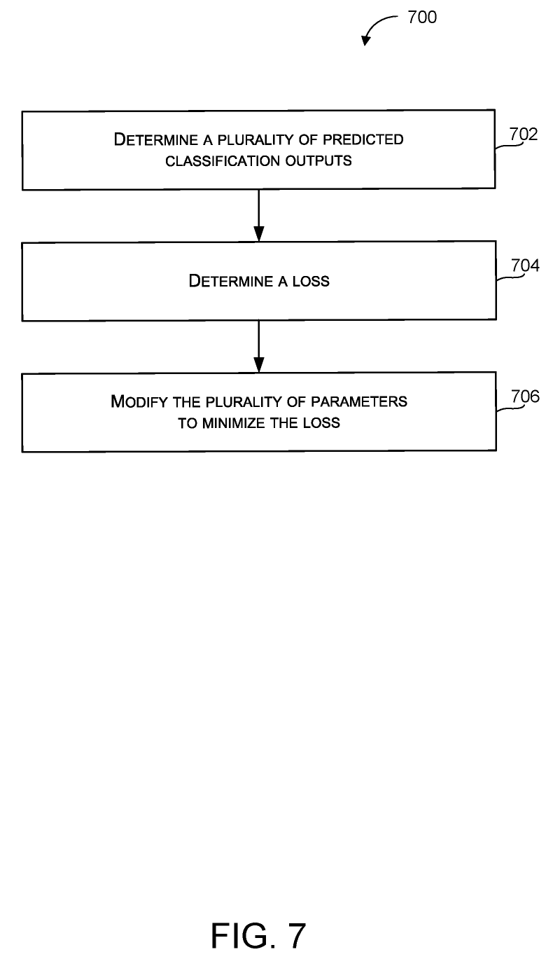

FIG. 7 depicts a flow chart diagram of an example method of training machine-learning models according to example embodiments of the present disclosure. One or more portions of the method 700 can be executed and/or implemented on one or more computing devices or computing systems comprising, for example, the computing device 102, the server computing system 130, the training computing system 150, and/or the computing device 300. Further, one or more portions of the method 700 can be executed or implemented as an algorithm on the hardware devices or systems disclosed herein. In some embodiments, one or more portions of the method 700 can be performed as part of the method 600 that is described with respect to FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining, based on inputting the plurality of annotated input samples into the one or more second machine-learned models, a plurality of predicted classification outputs. For example, the server computing system 130 can implement the one or more second machine-learned models. Based on inputting the plurality of annotated input samples into the one or more second machine-learned models, the one or more second machine-learned models can perform one or more operations and generate an output comprising a plurality of predicted classification outputs associated with the corresponding plurality of annotated input samples.

At 704, the method 700 can include determining a loss based on one or more differences between the plurality of predicted classification outputs and the plurality of classification outputs. For example, over a plurality of iterations, the server computing system 130 can determine a loss (e.g., an L2 loss) based on one or more differences between the plurality of predicted classification outputs and the plurality of classification outputs.

At 706, the method 700 can include modifying the plurality of parameters of the one or more second machine-learned models to minimize the loss. For example, the server computing system 130 can modify the weights of the plurality of parameters such that the weights of the plurality of parameters that contribute to reducing the loss (e.g., the parameters that increase the accuracy of the one or more second machine-learned models generating a plurality of predicted classification outputs that are accurate) are increased and/or the weights of the plurality of parameters that contribute to increasing the loss (e.g., the parameters that decrease the accuracy of the one or more second machine-learned models generating a plurality of predicted classification outputs that are accurate) are decreased. The plurality of weights of the plurality of parameters can be modified until some threshold loss that corresponds to a high accuracy of the plurality of predicted classification outputs is achieved.

Further to the descriptions above, a user may be provided with controls allowing the user to make an election as to both if and/or when systems, programs, or features described herein may enable collection of user information (e.g., a user’s images and/or a user’s preferences), and if the user is sent content or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method of training machine-learning models, the computer-implemented method comprising:
receiving, by a computing system comprising one or more processors, a plurality of input samples associated with a plurality of classification concepts;
generating, by the computing system, based on inputting the plurality of input samples into a first plurality of machine-learned models, a plurality of classification outputs comprising a plurality of labels and a plurality of confidence scores, wherein the first plurality of machine-learned models comprise one or more multimodal large language models (LLMs) and one or more domain-specific models;
generating, by the computing system, a plurality of annotated input samples comprising the plurality of input samples, the plurality of classification outputs, and a plurality of identifiers that identifies each of the first plurality of machine-learned models that generated each of the plurality of classification outputs; and
training, by the computing system, based on the plurality of annotated input samples, one or more second machine-learned models, wherein the training comprises modifying a plurality of parameters of the one or more second machine-learned models based on the plurality of confidence scores.

2. The computer-implemented method of claim 1, wherein the plurality of input samples are associated with a plurality of different conceptual domains.

3. The computer-implemented method of claim 2, wherein the one or more multimodal large language models are trained based on training data associated with the plurality of different conceptual domains.

4. The computer-implemented method of claim 2, wherein the one or more domain-specific models are trained based on the plurality of input samples associated with a subset of the plurality of different conceptual domains.

5. The computer-implemented method of claim 4, wherein the subset of the plurality of different conceptual domains comprises a single conceptual domain.

6. The computer-implemented method of claim 1, wherein the one or more multimodal large language models are configured to classify images associated with a plurality of different conceptual domains.

7. The computer-implemented method of claim 1, wherein the plurality of input samples comprise one or more images associated with a specific conceptual domain.

8. The computer-implemented method of claim 7, wherein the one or more domain-specific models are trained to classify images associated with the specific conceptual domain.

9. The computer-implemented method of claim 1, wherein the first plurality of machine-learned models are configured to classify images based on the plurality of input samples comprising the images and prompts associated with the images.

10. The computer-implemented method of claim 1, wherein the plurality of confidence scores indicate an accuracy associated with the plurality of labels generated by the first plurality of machine-learned models.

11. The computer-implemented method of claim 1, wherein the plurality of input samples comprises a plurality of images, a plurality of video segments, a plurality of audio samples, or a plurality of text segments.

12. The computer-implemented method of claim 1, wherein the training, by the computing system, based on the plurality of annotated input samples, one or more second machine-learned models comprises:
determining, by the computing system, based on inputting the plurality of annotated input samples into the one or more second machine-learned models, a plurality of predicted classification outputs;
determining, by the computing system, a loss based on one or more differences between the plurality of predicted classification outputs and the plurality of classification outputs; and
modifying, by the computing system, the plurality of parameters of the one or more second machine-learned models to minimize the loss.

13. The computer-implemented method of claim 12, wherein the loss is minimized based on use of an L2 loss function.

14. The computer-implemented method of claim 1, wherein a magnitude of the modification of the plurality of parameters is positively correlated with the magnitude of the plurality of confidence scores.

15. One or more tangible non-transitory computer-readable media storing computer-readable instructions that when executed by one or more processors cause the one or more processors to perform operations, the operations comprising:
receiving a plurality of input samples associated with a plurality of classification concepts;
generating, based on inputting the plurality of input samples into a first plurality of machine-learned models, a plurality of classification outputs comprising a plurality of labels and a plurality of confidence scores, wherein the first plurality of machine-learned models comprise one or more multimodal large language models (LLMs) and one or more domain-specific models;
generating a plurality of annotated input samples comprising the plurality of input samples, the plurality of classification outputs, and a plurality of identifiers that identifies each of the first plurality of machine-learned models that generated each of the plurality of classification outputs; and
training, based on the plurality of annotated input samples, one or more second machine-learned models, wherein the training comprises modifying a plurality of parameters of the one or more second machine-learned models based on the plurality of confidence scores.

16. The one or more tangible non-transitory computer-readable media of claim 15, wherein the one or more multimodal large language models comprise one or more multimodal large language models (LLMs).

17. The one or more tangible non-transitory computer-readable media of claim 15, wherein the one or more domain-specific models are trained to classify images associated with a specific conceptual domain.

18. A computing system comprising:
one or more processors;
one or more non-transitory computer-readable media storing instructions that when executed by the one or more processors cause the one or more processors to perform operations comprising:
receiving a plurality of input samples associated with a plurality of classification concepts;
generating, based on inputting the plurality of input samples into a first plurality of machine-learned models, a plurality of classification outputs comprising a plurality of labels and a plurality of confidence scores, wherein the first plurality of machine-learned models comprise one or more multimodal large language models (LLMs) and one or more domain-specific models;
generating a plurality of annotated input samples comprising the plurality of input samples, the plurality of classification outputs, and a plurality of identifiers that identifies each of the first plurality of machine-learned models that generated each of the plurality of classification outputs; and
training, based on the plurality of annotated input samples, one or more second machine-learned models, wherein the training comprises modifying a plurality of parameters of the one or more second machine-learned models based on the plurality of confidence scores.

19. The computing system of claim 18, wherein the one or more multimodal large language models comprise one or more multimodal large language models (LLMs).

20. The computing system of claim 18, wherein the one or more domain-specific models are trained to classify images associated with a specific conceptual domain.
